(19) United States
(12) Patent Application Publication
(10) Pub. No.: US 2026/0065635 A1
(43) Pub. Date: Mar. 5, 2026

(54) SYSTEM FOR ASSESSING CONTENT SIMILARITY

(71) Applicant: CopySight AI, Inc., Los Angeles, CA (US)

(72) Inventors: Tomasz Kornuta, San Jose, CA (US); Artem Petrov, Los Angeles, CA (US)

(21) Appl. No.: 18/824,039

(22) Filed: Sep. 4, 2024

(51) Int. Cl. G06V 10/74

(52) U.S. Cl. CPC G06V 10/761

(57) ABSTRACT

Systems, methods, and software are disclosed herein for assessing the similarity of visual content with respect to other visual content. In an implementation, a computing apparatus executes program instructions which direct the computing apparatus to identify reference images that are similar to a target image and to identify segments of the reference images that are similar to a segment of the target image. The program instructions further direct the computing apparatus to generate a similarity profile of the target image based on similarity scores of the segments of the reference images with respect to the target image.

### TECHNICAL FIELD

Aspects of the disclosure are related to the field of digital image processing.

### BACKGROUND

Generative artificial intelligence (AI) models for content generation, such as textual content or imagery, enable users to generate custom content based on natural language prompts, providing a simplified and streamlined approach to content creation which is accessible to users regardless of skill level. To generate custom content based on a natural language prompt, generative models are trained on vast amounts of existing content, such as text, images, and video scraped from the Internet as well as other sources. As such, the use of these AI models for content generation has given rise to novel legal issues of who the content creator actually is and whether a generated work is a derivative of an existing work. But while courts have only recently begun to grapple with these issues, the use of such models is rapidly becoming a commonplace tool for businesses.

When using generative AI models to create visual content, businesses often license exclusive rights to the generated content but not to the content itself, leading to potential intellectual property conflicts. The legal framework for content licensing struggles to keep pace with technological advancements, leaving creators and businesses in an area of legal uncertainty. Moreover, because models create content based on their broad-based training, the risk of unintentional intellectual property rights violations has surged with the integration of AI-generated content, such as images and videos, into commercial use. Thus, while these models present a significant advantage in facilitating the generation of customized content, businesses risk exposure to liability for infringing a protected work.

### OVERVIEW

Technology is disclosed herein for assessing the similarity of visual content with respect to other visual content. In an implementation, a computing apparatus executes program instructions which direct the computing apparatus to identify, from a database of images, reference images that are similar to a target image and to identify segments of the reference images that are similar to a segment of the target image. The program instructions further direct the computing apparatus to generate a similarity profile of the target image based on similarity scores of the segments of the reference images with respect to the target image.

In some implementations, the program instructions further direct the computing apparatus to generate clusters of the reference images according to metadata of the reference images and to filter the clusters of the reference images according to an aggregate similarity score based on the similarity scores of the reference images of the respective clusters.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a method for assessing the similarity of visual content in an implementation.

FIG. 2 illustrates an operational environment for assessing the similarity of visual content in an implementation.

FIGS. 3A and 3B illustrate workflows for assessing the similarity of visual content in an implementation.

FIG. 4 illustrates an operational scenario for assessing the similarity of visual content in an implementation.

FIGS. 5A-5F illustrates user experiences of a software application for assessing the similarity of visual content in an implementation.

FIG. 6 illustrates a method for assessing the similarity of visual content in an implementation.

FIG. 7 illustrates a computing system suitable for implementing the various operational environments, architectures, processes, scenarios, and sequences discussed below with respect to the other Figures.

### DETAILED DESCRIPTION

Various implementations are disclosed herein for technology for assessing the similarity of visual content (e.g., images, video) against existing content for potential intellectual property infringement issues, such as copyright or trademark infringement. In an implementation, a user submits an image, such as an AI-generated image, to determine whether the image (“target image”) or elements of the image are likely to infringe a copyright-protected work. The technology assesses the target image for potential infringement and flags specific elements of the image which may infringe a protected image. The scope of infringement detection is performed at the image level but extends to the segment- or element-level. By flagging elements of a target image for possible infringement, more granular information is captured by which the target image can be modified. The technology further enables multiple elements (e.g., segments) of the target image to be flagged for possible infringement of multiple intellectual properties. Based on assessing the target image for infringement, the technology also provides feedback by which the image can be modified to circumvent the possible infringement. The technology also enables tracking and documenting image development to demonstrate substantial human involvement in the development process. In various implementations, the technology also includes automated license generation for assigning rights to users for images generated and evaluated based on the technology. It may be appreciated that although some implementations described in the ensuing discussion refer to infringement of copyright-protected works, the technology disclosed herein is applicable to detecting substantial similarity with respect to trademark-protected images with no loss of generality.

In an exemplary scenario of the technology disclosed herein, a user elicits, from a generative AI model, the creation of an image (“target image”) for commercial use (e.g., marketing, advertising, branding). The target image is then processed by a software application to determine the potential of the target image to infringe an image with intellectual property protection. The likelihood may be, for example, an empirical probability of infringement of one or more protected images. To determine the likelihood of infringement, the application performs a similarity search of a database of protected images to identify a set of images to which the target image is most similar, that is to say, for which the target image and a protected image register a threshold level of similarity. In an implementation, to identify database images which are similar to the target image in the similarity search, the application computes a cosine or vector similarity score between an embedding of the target image and embeddings of each of the database images. The database images are then filtered by discarding the database images with vector similarities below the similarity threshold, yielding a set of reference images.

Having identified protected images which are similar to the target image (“reference images”), the application executes a segmentation model to segment the target image and the reference images, then generates a similarity profile for the target image which quantifies the similarity of the segments of the target image to segments of the reference images. Based on the similarity profile, particular segments of the target image can be flagged for review and modification. For example, a multi-modal generative AI model may be prompted to process the flagged segments against the segments of the reference images and regenerate the flagged segments to reduce the likelihood that the target image will infringe a protected work.

In some implementations, subsequent to identifying the reference images, the application computes the similarity scores for each reference image with respect to the target image, then filters the reference images according to similarity scores aggregated or clustered by image content, e.g., by image metadata. The metadata of the database images may include labels or tags which indicate image classifications, such as content categories to which an image belongs (e.g., cartoon, male, costume, superhero), the ownership of an image, or other characteristics of the image. To filter the reference images by metadata, the application computes an aggregate or cluster similarity score for each tag of the reference images based on the similarity scores of the images with the respective tag. For example, to calculate the similarity score for the image tag “anthropomorphic,” the application calculates an average of the similarity scores for every image tagged “anthropomorphic.” With a similarity score for every tag of the reference images calculated, the reference images can be filtered to retain the images of the metadata clusters which exceed a threshold level of similarity. In some scenarios, to the reference images are further filtered based on the number of images associated with each tag, and images which are solely associated with infrequently occurring metadata tags are discarded, adding further refinement to the process and reducing processing costs.

In an implementation, to identify reference images from the database images, the application performs a cosine or vector similarity search of vector representations of the database images as compared to a vector representation of the target image. The vector representations may be vector embeddings generated based on the images while the similarity search may be a cosine similarity search which computes a geometric distance between the vector representations, yielding for each database image a similarity score with respect to the target image. The database images may be filtered according to the similarity scores (of the database images or of clusters of images) to retain the highest scoring images—the reference images.

Continuing with the similarity assessment, in an implementation, to identify segments of the target image which bear some similarity to segments of the reference images, in an implementation, the application computes a cosine similarity score for each segment of the target image with respect to segments of the reference images based on embeddings of the segments. The similarity scores are aggregated (e.g., averaged) according to target image segment. The similarity profile of the target image is generated as a composite of the aggregated scores. In some scenarios, another level of aggregation of segment scores is based on the image metadata. For example, the metadata (e.g., tags) of the reference images may be used to compute similarity scores according to metadata as well as by target image segment. Segments of the target image yielding high similarity scores (reflecting greater similarity to segments of the database images) can be flagged for review and modification. The similarity profile can also be used to generate an overall similarity score for the target image. An overall similarity score might be used, for example, when comparing multiple target images in a selection process.

In an implementation, the database of protected images to which the target image is compared are tagged according to content or other classifications which are then used for clustering. The protected images may be obtained from image databases, Internet sources, registered copyright databases, trademark databases, likenesses of famous individuals, and the like. In some scenarios, the images may be drawn from a cooperative database which allows copyright owners to opt-in by supplying images of the copyrighted work to protect against noninfringement. In various scenarios, a large database of copyrighted images may be initially filtered according to image tags or other metadata prior to performing a similarity search against the target image to reduce the volume of content that must be processed.

In some implementations, when a similarity profile of a target image has been generated by the application, information in the profile is used to revise the target image. For example, the similarity profile may include similarity scores or grades of the segments of the target image. For segments with scores indicating high similarity or high potential for infringement (e.g., exceeding a threshold risk of infringement), the application may prompt a generative AI model (such as the model which created the target image) to modify the image to reduce the similarity of the high-similarity segments. Along with the target image, the prompt may also include various ones of the reference images or segments of the reference images as negative examples for the model (i.e., what the model should not do). The application assesses the revised image generated by the model for similarity in the same manner as the original target image. The process or cycle of (re) generation, similarity assessment, and modification continues until the segments of the target image are below the threshold risk of infringement. Throughout the process, the actions performed with respect to the target image and the similarity assessments are captured and stored as part of the documentation or record of image creation.

In some scenarios, target images to be evaluated for similarity against protected images may be manually created images rather than AI-generated images. The similarity scoring or profile generated for a manually created image can be used by the artist to modify the image to avoid possible infringement issues.

In various implementations, when the similarity profile of the target image indicates that the target image is not likely to infringe a protected image, the application automatically generates a licensing agreement including a depiction of the target image by which the user can obtain rights to the commercial use of the image. The user may also obtain documentation relating to creation and development of the image to demonstrate substantial human involvement, such as user input prompting the image creation, creative choices made by the user in editing the image, similarity profiles of versions of the image during development, and the final product.

Generative AI models of the technology disclosed herein include large-scale foundation models trained on massive quantities of diverse, unlabeled data using self-supervised, semi-supervised, or unsupervised learning techniques. Such models may be based on a number of different architectures, such as generative adversarial networks (GANs), variational auto-encoders (VAEs), and transformer models, including multi-modal transformer models. Generative AI models include BERT (Bidirectional Encoder Representations from Transformers) and ResNet (Residual Neural Network). In some scenarios, a generative AI model may be fine-tuned for specific downstream tasks. Fine-tuning a generative AI model involves adjusting the parameters of the pretrained model according to a specific dataset to adapt the model's output to a particular task. Foundation models may be multi-modal or unimodal depending on the modality of the inputs.

Multi-modal models, including multi-modal large language models (LLMs), are a class of generative AI model which extend their pre-trained knowledge and representation capabilities to handle multi-modal data, such as text, image, video, and audio data. Multi-modal models can generate an image based on a text description (or, in some scenarios, a spoken description transcribed by a speech-to-text engine) or an image or both. Multi-modal models include visual-language foundation models, such as CLIP (Contrastive Language-Image Pre-training), ALIGN (A Large-scale ImaGe and Noisy-text embedding), and VILBERT (Visual-and-Language BERT), for computer vision tasks. Examples of visual multi-modal or foundation models include DALL-E, DALL-E 2, Flamingo, Florence, and NOOR.

Technical effects of the technology disclosed herein include a process for detecting similarity between images at the image- and segment-level to provide a comprehensive similarity assessment of a target image. To optimize the process of assessing the similarity of a target image against a vast database of protected images, the disclosed technology includes an initial filtering of the images based on computing similarity scores and aggregating the scores according to image metadata. Subsequent to identifying images similar to the target image, a similarity search based on image segments is performed. By parsing and quantifying similarity by image segments, a comprehensive understanding of similarity and potential intellectual property infringement issues is obtained. Further, by detecting similarity of segments of the target image to segments of protected images, the target image can be modified to reduce the likelihood of infringement. Moreover, the similarity profile generated for the target image can be used to create a natural language prompt to elicit a modified version of the image from an AI image generation model.

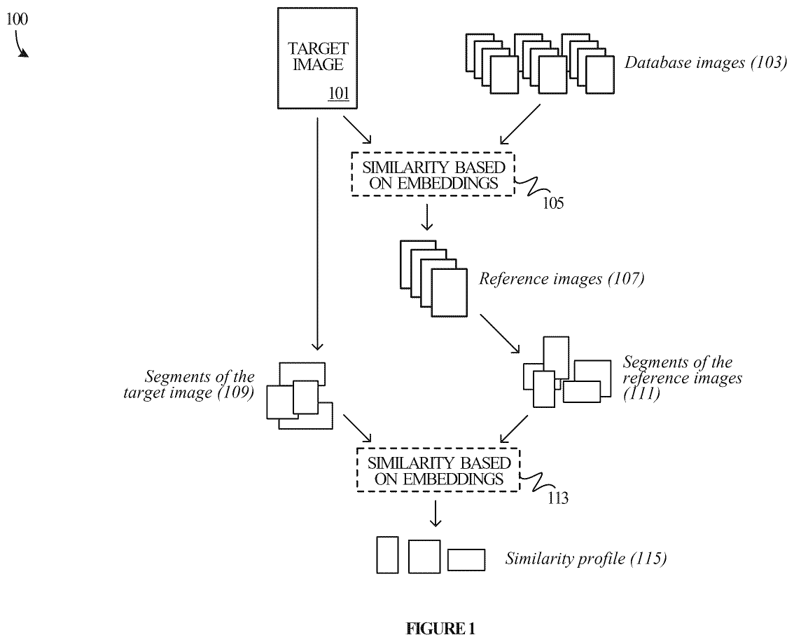

Turning now to the Figures, FIG. 1 illustrates a method for assessing the similarity of a target image with respect to existing images such as copyright-protected images in an implementation. Process 100 may be performed by program instructions executing on a computing device such as desktop or laptop computer, mobile device (e.g., tablet computer or smartphone), or a server computer. As illustrated, process 100 is performed with respect to target image 101. In an implementation, target image 101 may be created by a user within a software application (e.g., a graphic design application), by a generative AI model based on a natural language prompt from a user, by a combination (e.g., an AI-generated image which has been manually modified by the user), or by other means. The format or file type of target image 101 may be a .PNG, .GIF, .JPEG, .RAW, or other file type which stores image data.

In process 100, the computing device receives target image 101 and performs similarity search 105 to identify images of database images 103 which are similar to target image 101 (e.g., exhibiting a similarity score with respect to target image 101 which exceeds a similarity threshold). The similarity search is performed with respect to vector representations of target image 101 and database images 103. (The vector representations include data structures comprising data values defining an image which are organized in an array and which are accessible by an index corresponding to each position in the array.) In an implementation, in executing the similarity search, a cosine similarity calculation is performed for each image of database images 103 with respect to target image 101. The images are then filtered according to the scores to retain the images that bear some threshold-level of similarity to target image 101—reference images 107—and to filter out the images that are less similar to target image 101.

In some implementations, clusters (not shown) of database images 103 are generated based on the metadata of the images, such as content classification tags. Database images 103 are filtered to retain images associated with the higher-scoring clusters (i.e., associated with clusters with higher average similarity scores), while images associated solely with lower-scoring clusters are filtered out.

Continuing with process 100, target image 101 and reference images 107 are segmented to produce target image segments 109 and segments of reference images (“reference segments”) 111. In various implementations, the computing device may supply the images to a convolutional neural network to perform bounding box segmentation or semantic segmentation to segment the images. The computing device performs similarity search 113 with respect to target image segments 109 and reference segments 111. As with similarity search 105, vector representations of each segment of the target image segments 109 and reference segments 111 are generated and a cosine similarity search is performed on each of reference segments 111 with respect to each of target image segments 109. An aggregate score can be calculated for a given segment of target image segments 109 based on the similarity scores of reference segments 111 with respect to the given segment. The aggregate scores of target image segments 109 form similarity profile 115 for target image 101. Similarity profile 115 may include identification or flagging of particular ones of target image segments 109 for which the aggregate similarity score exceeds a threshold value. Similarity profile 115 may also include information such as an overall probability or likelihood that target image 101 infringes a copyrighted image of database images 103. In some cases, similarity profile 115 includes information by which a natural language prompt can be configured for a generative AI model to modify target image 101 to reduce the likelihood of infringement and may include selected images or segments of images of database images 103 as negative examples for the model.

In some implementations, after segmentation, reference segments 111 retain their associations with the clusters generated based on the image metadata. By retaining the metadata associations, the similarity profile resulting from similarity search 113 provides additional contextual information about the potential for copyright infringement of the content of reference images 107.

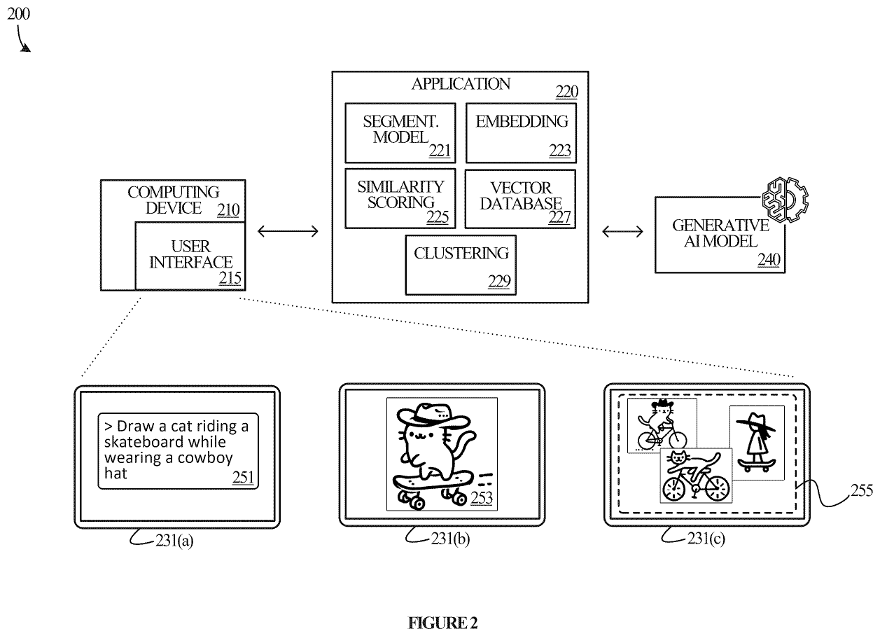

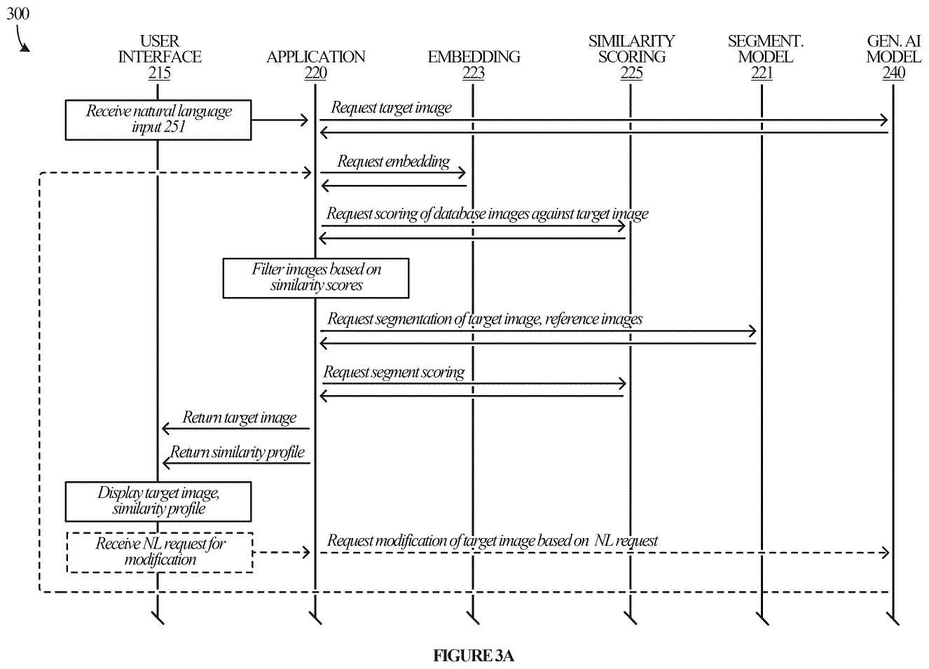

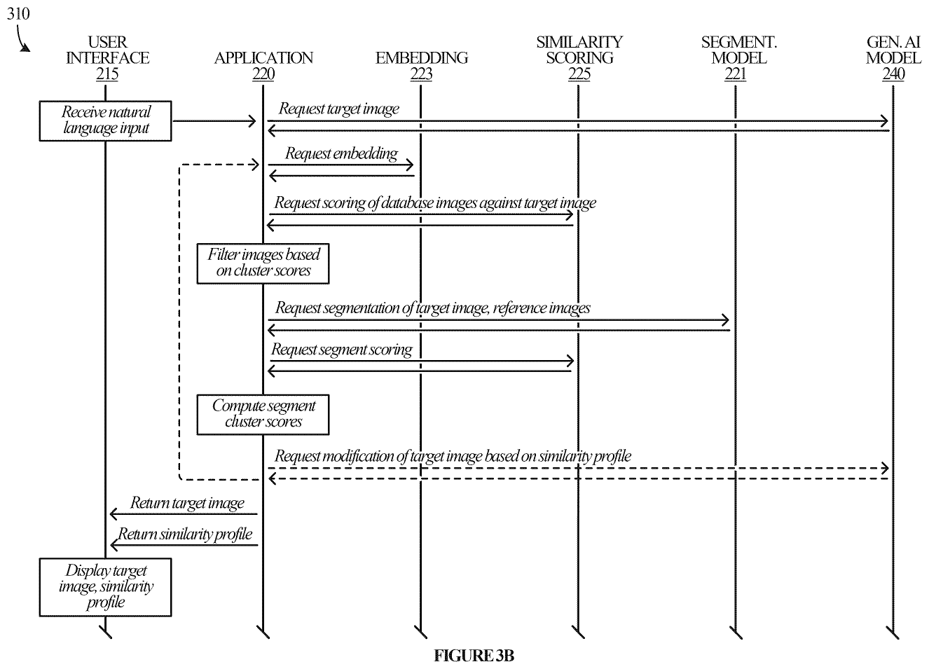

FIG. 2 illustrates operational environment 200 for assessing the similarity of a target image with respect to copyright-protected images in an implementation. Operational environment 200 includes computing device 210 hosting user interface 215, application 220, and generative AI model 240. Application 220 includes segmentation model 221, embedding module 223, similarity scoring module 225, vector database 227, and clustering module 229. User interface 215 hosts user experiences 231 (a), 231 (b), and 231 (c) of application 220. FIGS. 3A and 3B describe operational scenarios involving elements of operational environment 200, discussed infra.

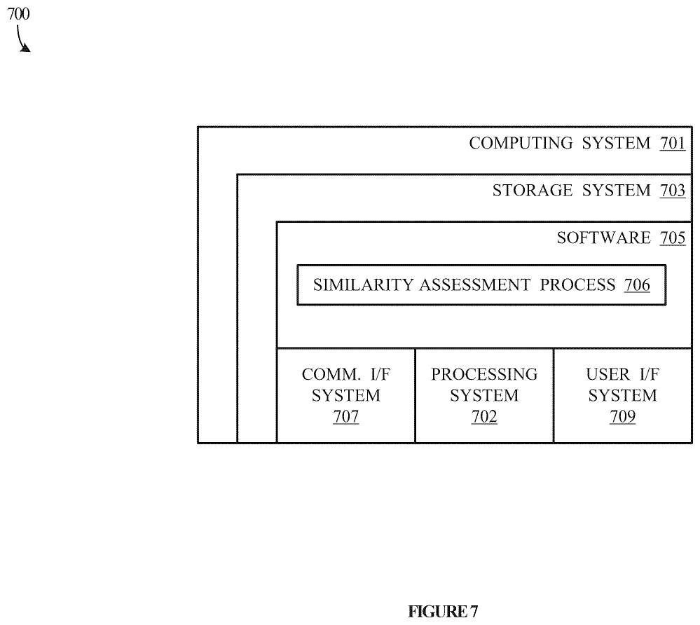

Computing device 210 is representative of a computing device, such as a laptop or desktop computer, or mobile computing device, such as a tablet computer or cellular phone, of which computing system 701 in FIG. 7 is broadly representative. A user interacts with application 220 via user interface 215 displayed on computing device 110. User experiences 231 (a), 231 (b), and 231 (c) displayed on computing device 210 are representative of user experiences of an application environment of application 220 in an implementation.

Application 220 is representative of a software application including functionality for evaluating visual content for potential infringement of intellectual property protection. Application 220 may be a graphical design application, project planning application, or other application providing functionality for content creation (e.g., Microsoft® Designer, Canva®, etc.). Application 220 may execute locally on a user computing device, such as computing device 210, or application 220 may execute on one or more servers in communication with computing device 210 over one or more wired or wireless connections, causing user interface 215 to be displayed on computing device 210. In some scenarios, application 220 may execute in a distributed fashion, with a combination of client-side and server-side processes, services, and sub-services. For example, the core logic of application 220 may execute on a remote server system with user interface 215 displayed on a client device. In still other scenarios, computing device 210 is a server computing device, such as an application server, capable of displaying user interface 215, and application 220 executes locally with respect to computing device 210.

Application 220 executing locally with respect to computing device 210 may execute in a stand-alone manner, within the context of another application such as a presentation application or word processing application, or in some other manner entirely. In an implementation, application 220 hosted by a remote application service and running locally with respect to computing device 210 may be a natively installed and executed application, a browser-based application, a mobile application, a streamed application, or any other type of application capable of interfacing with generative AI model 240 and providing local user experiences displayed in user interface 215 on the remote computing device.

Application 220 provides a local user experience, as illustrated by user experiences 231 (a), 231 (b), and 231 (c) via user interface 215. In user interface 215, user experiences 231 (a), 231 (b), and 231 (c) are representative of local user experiences hosted by application 220 in an implementation. In user experience 231 (a), an interface is displayed by which to receive input 251 from a user. Output generated by generative AI model 240 in response to input 251 includes image 253 depicted in user interface 231 (b). Reference images 255 in user experience 231 (c) depict images identified by application 220 as bearing some similarity to image 253.

Generative AI model 240 is representative of one or more deep learning models trained in image generation or generative pretrained transformer (GPT) computing models or architectures, such as Dall-E or GPT-4/4V. Generative AI model 240 is hosted by one or more computing services which provide services by which application 220 can communicate with the model, such as an application programming interface (API). In communicating with application 220, generative AI model 240 may send and receive information (e.g., prompts and replies to prompts) in data objects, such as JavaScript Object Notation (JSON) objects. Generative AI model 240 may be implemented in the context of one or more server computers co-located or distributed across one or more data centers.

FIGS. 3A and 3B illustrate workflows 300 and 310, respectively, for evaluating the similarity of an image against a database of images, referring to elements of FIG. 2 in an implementation. In workflow 300 of FIG. 3A, user interface 215 receives natural language input 251 including an intent by the user for an image to be created by generative AI model 240. Application 220 configures a prompt including input 251 to elicit an image responsive to the user's intent from generative AI model 240. Application 220 receives output including image 253 generated in response to the prompt.

Next, application 220 generates a similarity assessment of image 253 to detect possible infringement of a copyright-protected work. To generate the assessment, application 220 calls embedding module 223 to generate a vector representation of image 253 for a similarity search against images of vector database 227. The vector representation of an image such as image 253 includes coordinates of a point representation of the image in a high-dimensional space. Vector database 227 includes vector representations of copyright-protected images against which target images such as image 253 are to be evaluated for possible copyright infringement.

Application 220 executes a vector similarity search of vector database 227 to identify copyright-protected images to which image 253 bears some similarity. To execute the similarity search, application 220 calls similarity scoring module 225 which computes similarity scores for the images represented in vector database 227 based on vector or cosine similarity (e.g., based on computing a Euclidean distance between the point representations of image 253 and each of the images embodied in vector database 227). Application 220 filters the images of vector database 227 based on the similarity scores to identify a set of images which are similar to image 253, represented by reference images 255. In an implementation, application 220 filters the images based on the respective similarity scores exceeding a similarity threshold.

Having identified reference images 255 based on the similarity scores, application 220 calls segmentation model 221 to segment image 253 and reference images 255, for example, by submitting the images to a convolutional neural network for segmentation. Application 220 performs a second similarity search, this time of the segments of reference images 255 against the segments of image 253. For example, multiple segments may be identified from image 253: a cat, a cowboy hat, a skateboard, a cat wearing a hat, and so on. For each of the identified segments, application 220 computes an aggregate similarity score based on the second similarity search. For example, the similarity score for the cat segment of image 253 may be an average of similarity scores of segments of reference images 255 which register at least a threshold similarity.

Having generated aggregate similarity scores for the various segments of image 253, application 220 generates a similarity profile for image 253. The similarity profile may include the aggregate similarity scores of the various segments along with a composite similarity score for image 253. The similarity profile may also include information relating to the metadata associated with the clusters of reference images 255, indicating the particular types of content which image 253 broadly resembles.

In some instances, application 220 may generate a natural language prompt by which to modify image 253 to reduce the similarity scores of various segments of image 253. For example, one or more segments of image 253 may be flagged for undue similarity to segments of images of vector database 227. Application 220 may generate a prompt (e.g., by customizing a prompt template) which tasks a generative AI model to modify image 253 to reduce the detected similarity of the flagged segments. As illustrated in workflow 300, application 220 may prompt generative AI model 240 to generate a modified version of image 253 in accordance with the natural language prompt, then execute a new cycle of similarity assessment for the modified image, e.g., calling embedding module 223 to generate a vector representation of the modified image, performing similarity search of vector database 227 against the modified image, and so on.

The cycle of modifying and evaluating modified images may continue until a similarity profile is generated which indicates that none of the segments of target image 101 exceeds a similarity threshold or that composite score of the image indicates a low likelihood of infringement. When the such an image is discovered according to workflow 300, the image is presented to the user in user interface 215 along with the corresponding similarity profile.

Workflow 310 of FIG. 3B proceeds similarly to workflow 300 but presents an alternative implementation of filtering images subsequent to the similarity search to identify reference images 255. In workflow 310, having generated similarity scores for the vector representations of vector database 227 against image 253, application 220 performs an initial filtering to identify a set of images bearing a threshold level of similarity to image 253. Application 220 then calls clustering module 229 to cluster the images according to the image metadata. For example, the images represented in vector database 227 may include labels or tags which categorize the images according to content, copyright ownership, or other attributes. Application 220 clusters the images corresponding to each image tag and computes an aggregated similarity score for each cluster based on the similarity scores of the images in the respective clusters. Application 220 then filters out clusters according to a threshold cluster similarity score, retaining the images corresponding to higher-scoring clusters as represented by reference images 255.

Continuing with workflow 310, subsequent to segmenting reference images 255, application 220 computes segment cluster scores. Segment cluster scores aggregate the similarity scores of the segments of reference images 255 according to the segments of image 253 but also according to the clusters corresponding to the metadata of reference images 255. As such, the segment cluster scores provide a more granular indication of similarity between reference images 255 and image 253 in the similarity profile for image 253. Workflow 310 proceeds as described above for workflow 300.

In some implementations, the steps of workflows 300 and 310 for evaluating the similarity of a target image against a database of images may be performed with respect to a target image which has been uploaded or exported to application 220. For example, the user may generate the target image in a third-party design application or by an alternative AI model for image generation, then export an image file (.jpg, .png, .gif, etc.) to application 220 which proceeds with requesting an embedding of the image from embedding module 223, and so on. So, for example, if the user receives the target image in proposal for a product branding campaign, the user can evaluate the similarity of the target image according to the technology disclosed herein.

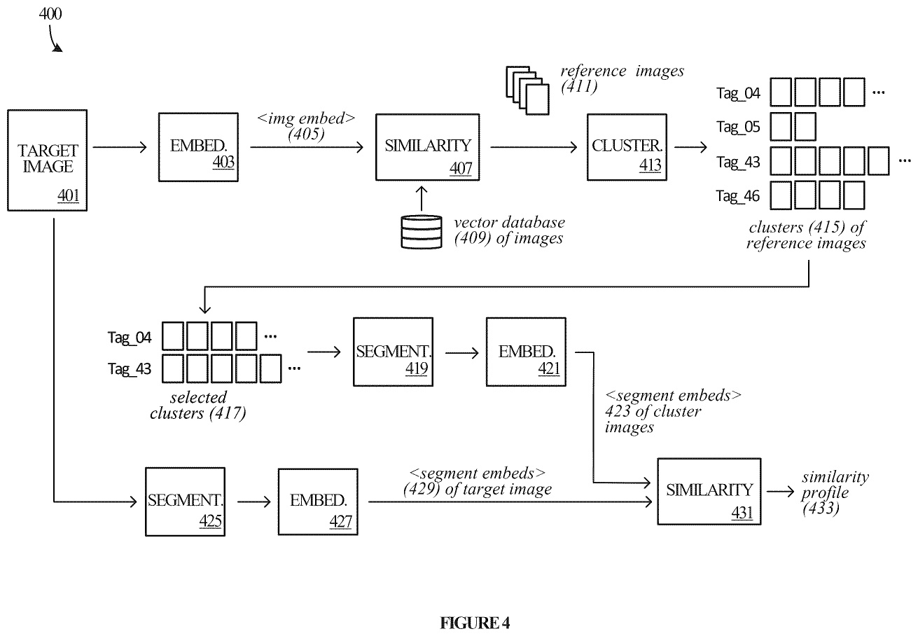

FIG. 4 illustrates operational scenario 400 for assessing similarity of a target image for possible intellectual property infringement in an implementation. Operational scenario 400 may be performed by a software application, such as application 220 of FIG. 2, which generates similarity profile 435 for target image 401.

In operational scenario 400, the application receives target image 401 and performs image embedding 403 yielding image embedding 405 of target image 401. To generate a vector representation or embedding, target image 401 is converted into a numerical format that captures its essential features in a compact vector for data analysis tasks such as similarity searching.

Next, the application performs similarity search 407 to identify images of vector database 409 which are similar to target image 401, depicted by reference images 411. Vector database 409 includes vector representations of the various images generated by an embedding module in the same manner as image embedding 403. To identify reference images 411, the application performs a similarity search (407) which computes similarity scores of the vector representations of vector database 409 against image embedding 405 of target image 401 and selects reference images 411 based on the similarity scores, for example, selecting the images according to similarity scores exceeding a threshold value or a percentage of the highest-scoring images ordered by score.

Next, the application performs clustering 413 which clusters reference images 411 according to metadata of the images, yielding clusters 415. In an implementation, the images of vector database 409 are tagged according to content and other classifications. Clusters 415 are generated for every tag which occurs in reference images 411. Various ones of clusters 415 are then filtered out (i.e., discarded from further analysis) based on an aggregate similarity score of the images in the respective cluster, so that clusters with the highest aggregate (e.g., average) similarity scores are retained, yielding selected clusters 417. The application performs segmentation 419 of the images of selected clusters 417 and performs embedding 421 the segments, yielding segment embeddings 423 of the images of selected clusters 417.

Continuing with operational scenario 400, the application performs segmentation 425 and embedding 427 of target image 401 to generates segment embeddings 429 of target image 401. The application performs similarity search 431 of segment embeddings 423 of the images of selected clusters 417 with respect to segment embeddings 429 of target image 401. Similarity search 431 quantifies the similarities between the segment embeddings and generates an aggregate similarity score by averaging the similarity scores across each of the segment embeddings of segment embeddings 429 of target image 401. Similarity search 431 may also quantify the similarities by aggregating according to metadata cluster as well as segment embeddings 429 of target image 401, providing a more granular understanding of similarity. In this way, similarity search 431 yields similarity profile 433 for target image 401 including evaluations of segments embeddings 429 with respect to similarity to images of vector database 409.

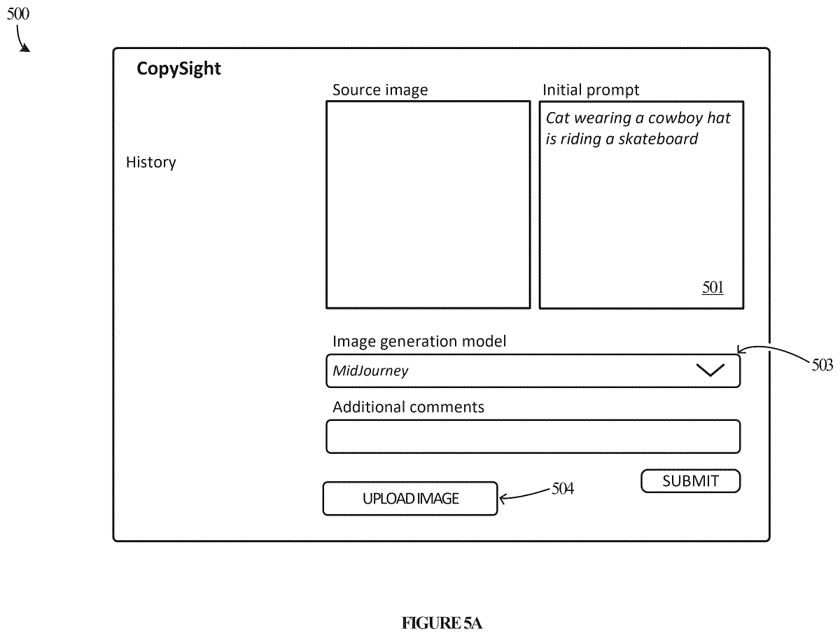

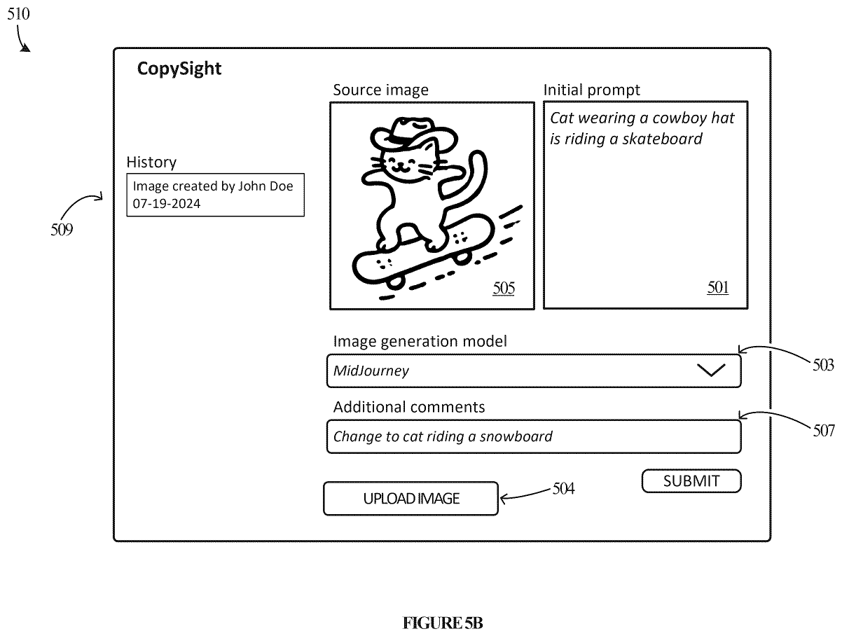

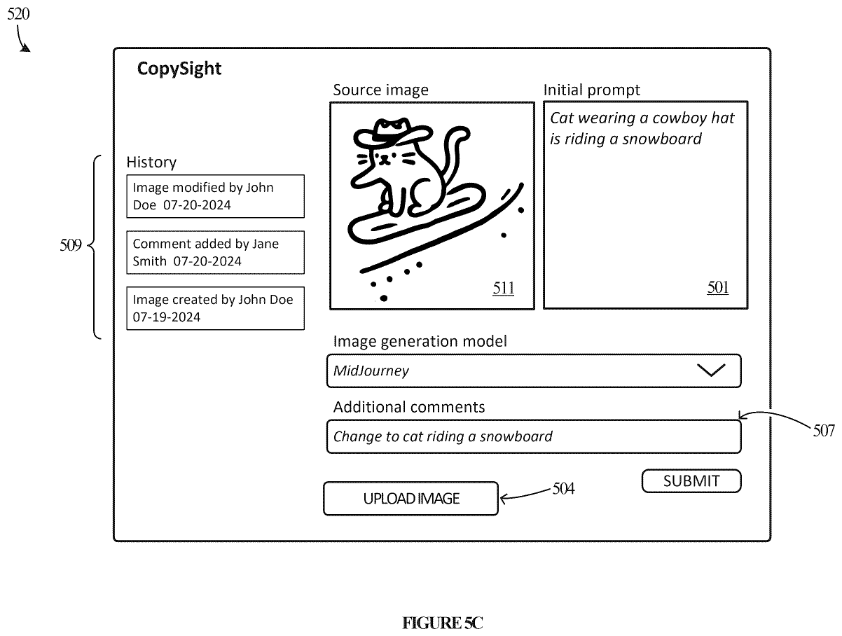

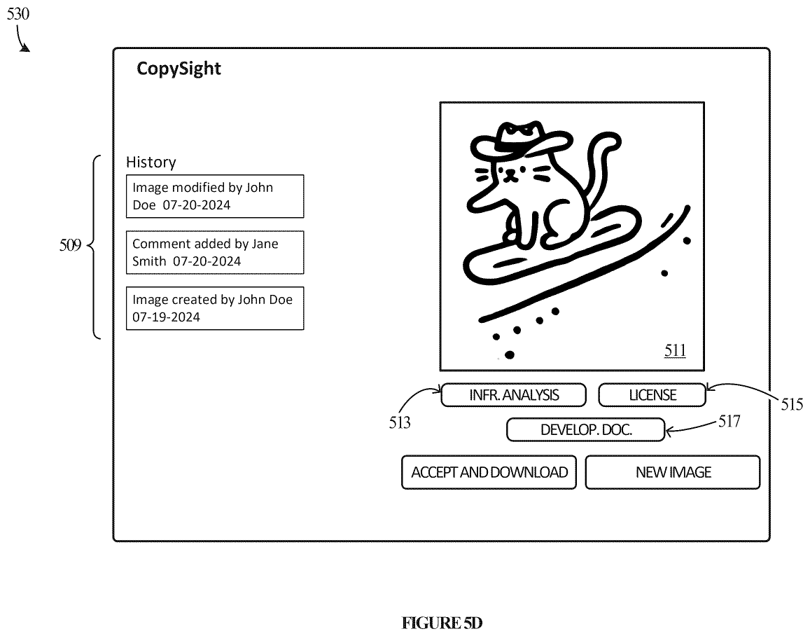

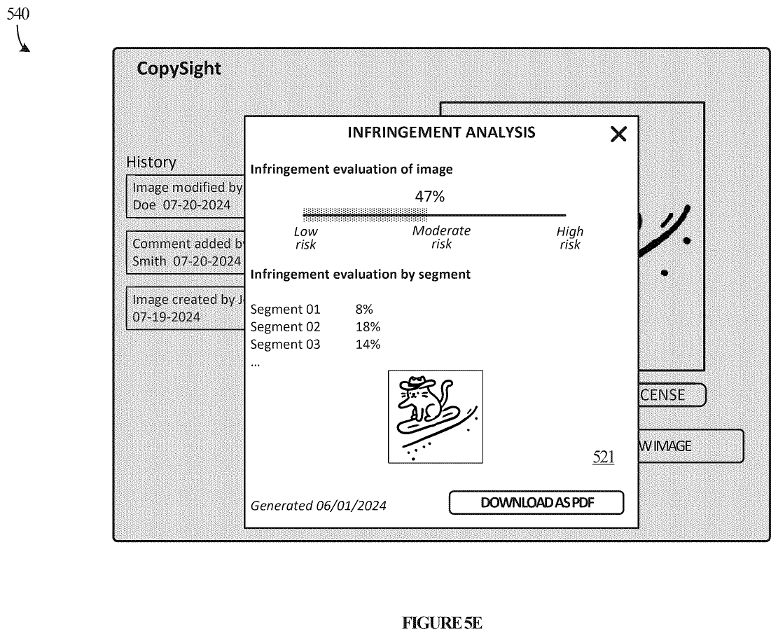

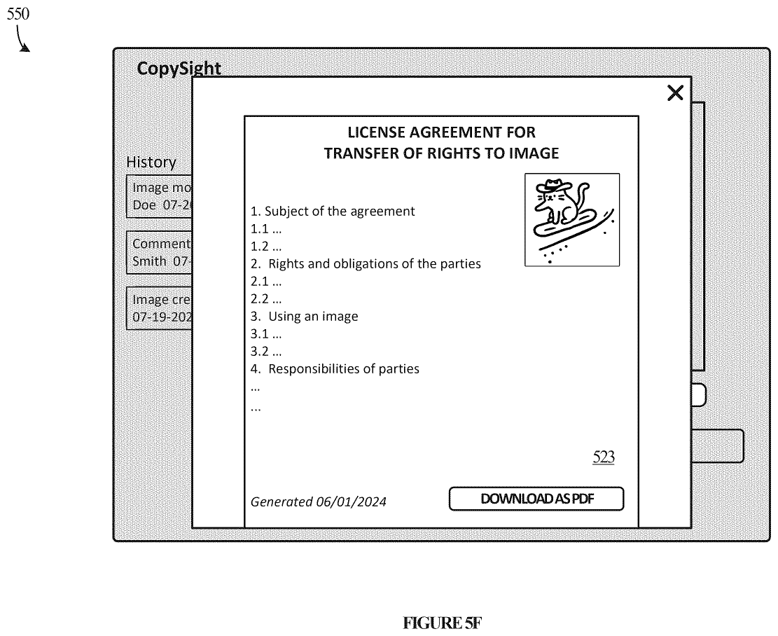

FIGS. 5A-5F depict user experiences 500-550 for an operational scenario for an application for generating an image based on a request from a user, evaluating the image against other images, e.g., protected images, for possible intellectual property infringement, and documenting the image creation process in an implementation.

In user experience 500 of FIG. 5A, a user enters natural language input 501 for an image to be generated. In various implementations, the user may also select the desired AI image generation model (e.g., using graphical button 503) to be used for creating and/or modifying an image.

In some scenarios, the user may wish to evaluate an existing image against other images for possible intellectual property infringement. User experience 500 includes graphical button 504 by which the user can upload a previously generated target image, such as an image which has been generated within the context of a different application or by another AI model. The user can execute a similarity analysis, request revisions, and perform other steps described in relation to FIGS. 5A-5F with respect to the uploaded image. For example, the user can supply information relating to the human involvement in the creation of the previously generated image to document the history of the image.

In user experience 510 of FIG. 5B, target image 505 has been generated by and received from the selected image generation model. Information relating to image generation, including natural language input 501, is documented and stored, as indicated in history 509. Having received target image 505, the user enters a comment (depicted in comment box 507) to modify target image 505. Continuing to user experience 520 of FIG. 5C, the application submits a prompt including target image 505, natural language input 501, and the comment provided in comment box 507 to the image generation model to modify the image. The resulting revised image 511 is received and displayed in user experience 520. History 509 is updated to include the comment and information relating to generating revised image 511.

In user experience 530 of FIG. 5D, the user has indicated an acceptance of revised image 511 which causes various options to be presented in the user interface. Graphical button 513 causes the application to perform a similarity analysis resulting in a similarity profile of revised image 511 which provides an indication of the likelihood the image infringes a copyrighted work. Graphical button 515 causes the application to generate and surface a licensing agreement for revised image 511 by which the user/creator can obtain rights for commercial usage of the image. Graphical button 517 causes the application to generate and return documentation relating to the generation of revised image 511, for example, including information reflected in history 509 and exhibits of the image at various stages of creation and development.

In user experience 540 of FIG. 5E, the user has selected graphical button 513 which causes the application to generate a similarity profile for revised image 511 and surface information from the similarity profile in document 521. As illustrated, document 521 includes an evaluation of the likelihood that revised image 511 and various segments of revised image 511 will infringe a copyrighted work. The user can, if desired, download a PDF of document 521.

In user experience 550 of FIG. 5F, the user has selected graphical button 515 which causes the application to generate and surface a licensing agreement for revised image 511. As illustrated, document 523 includes a licensing agreement generated for revised image 511. The licensing agreement may include a copy of the image along with a unique identifier (e.g., a hash code) for the image. Here, too, the user can download the agreement as a PDF.

It may be appreciated that user experience 500 can be adapted for scenarios where a target image has been generated outside the context of user experience 500 and uploaded to the application for a similarity analysis.

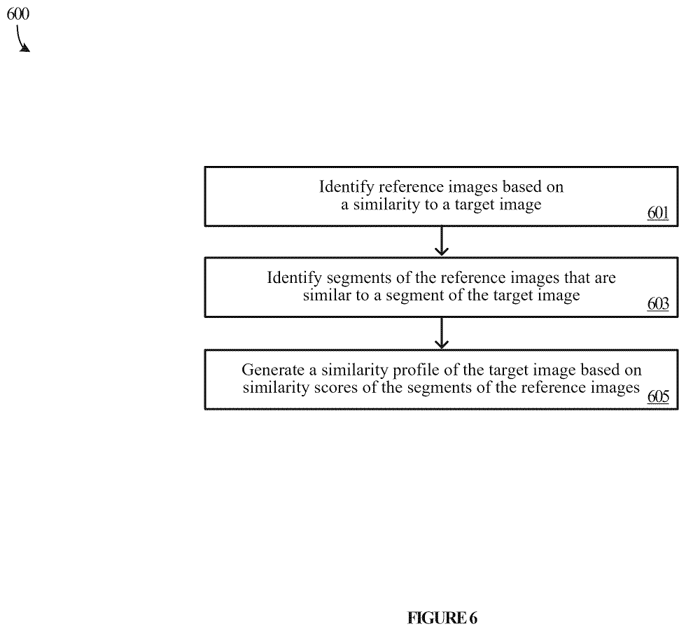

FIG. 6 illustrates a method for assessing the similarity of a target image with respect to other images (e.g., images with intellectual property protection) in an implementation, herein referred to as process 600. Process 600 may be implemented in program instructions in the context of any of the software applications, modules, components, or other such elements of one or more computing devices. The program instructions direct the computing device(s) to operate as follows, referred to in the singular for the sake of clarity.

The computing device identifies reference images based on a similarity to a target image (step 601). In an implementation, the computing device calculates embeddings for the target image and for a group or database of protected images (e.g., copyright-protected images, trademark images) to which the target image may be similar. To calculate the embeddings, the computing device may generate a vector representation of each database image in high-dimensional space. To determine the similarity between the target image and the database images, the computing device calculates a similarity score based on cosine similarity, i.e., the Euclidean distance between the target image vector and each vector of the database images. In this way, the cosine similarity indicates the similarity between the target image and a database image.

The database images are then filtered according to similarity score (e.g., the Euclidean distance) to retain the database images which are more similar to the target image (i.e., the reference images) and discard the less similar images. For example, a database image is retained as a reference image if its similarity score exceeds a threshold similarity value.

In some implementations, the identification of reference images is based on clusters of the database images which are generated according to the metadata of the images. For example, the metadata of the database images may include tags be which to categorize the images by content, ownership, or other content-relevant information. A cluster score is then calculated for each cluster of images based on the similarity scores of the images in the respective cluster. The clusters are then filtered based on the cluster score. For example, a cluster of database images is retained if the cluster score exceeds a threshold similarity value. In some cases, clusters are also filtered based on whether the cluster includes a minimum number of images.

The computing device identifies segments of the reference images that are similar to a segment of the target image (step 603). In an implementation, the computing device executes a segmentation model to segment the target image and the reference images of the database images. Embeddings are calculated for each segment of the target images and the segments of the reference images identified in step 601. The segments of the reference images are then compared to and scored for similarity against each segment of the target image. For example, a cosine similarity is computed for between each combination of target image segment and reference image segment. With similarity scores computed between the segments, the similarity scores are aggregated (e.g., averaged) across the target image segments to generate an aggregate score for each segment of the target image.

In an implementation, the segmentation may be performed on the database images which were clustered according to the image metadata. The segments are clustered according to the image metadata of the images from which the segments were extracted. Subsequent to generating a similarity score for each segment with respect to a specified target image segment, the segment scores are aggregated (e.g., averaged) according to cluster and target image segment, yielding segment cluster scores for each target image segment.

For ease of description, a highly simplified example of similarity scoring based on image clusters follows. A target image includes Segments 1, 2, and 3. A first reference image, with metadata tags X and Y, includes Segments A, B, and C. A second reference image, with metadata tags X and Z, includes Segments D, E, and F. Similarity scores are generated based on (embeddings of) segment pairs 1A, 1B, IC, ID, IE, IF, 2A, 2B, 2C, 2D, 2E, 2F, 3A, 3B, 3C, 3D, 3E, and 3F. The scores are then clustered and aggregated according to target image segment and metadata. Thus, for target image Segment 1, the segment cluster score for metadata X includes an aggregation of scores for 1A, 1B, IC, ID, IE, and IF. Similarly, for target image Segment 2, the segment cluster score for metadata Z includes an aggregation of scores for 2D, 2E, and 2F.

The computing device generates a similarity profile of the target image based on similarity scores of the segments of the reference images (step 605). In an implementation, the similarity profile includes the aggregate scores for each segment of the target image along with a composite similarity score for the target image based on the aggregate scores. In some cases, the profile may flag particular segments of the target image which exceed a threshold similarity value. The similarity profile may also include information which indicates a likelihood of infringement based on the various similarity scores.

FIG. 7 illustrates computing device 701 that is representative of any system or collection of systems in which the various processes, programs, services, and scenarios disclosed herein may be implemented. Examples of computing device 701 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes and implements similarity assessment process 706, which is (are) representative of the similarity assessment processes discussed with respect to the preceding Figures, such as process 100 and workflows 300 and 310. When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including similarity assessment process 706) may be implemented in program instructions and among other functions may, when executed by processing system 702, direct processing system 702 to operate as described with respect to the various operational scenarios, sequences, and processes illustrated herein. For example, software 705 may include program instructions for implementing a similarity assessment process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to support similarity assessment of visual content in an optimized manner. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
identify, from a database of images, reference images that are similar to a target image;
identify segments of the reference images that are similar to a segment of the target image; and
generate a similarity profile of the target image based on similarity scores of the segments of the reference images with respect to the target image.

2. The computing apparatus of claim 1, wherein the program instructions further direct the computing apparatus to generate clusters of the reference images according to metadata of the reference images.

3. The computing apparatus of claim 2, wherein the program instructions further direct the computing apparatus to filter the clusters of the reference images according to aggregate similarity scores of the clusters, wherein the aggregate similarity scores of the clusters are based on similarity scores of the reference images of the respective clusters with respect to the target image.

4. The computing apparatus of claim 1, wherein to identify the reference images that are similar to the target image, the program instructions direct the computing apparatus to determine a vector similarity score for each image of the database of images, wherein the vector similarity score indicates a similarity of the image to the target image based on embeddings of the target image and the image.

5. The computing apparatus of claim 1, wherein to identify the segments of the reference images that are similar to the segment of the target image, the program instructions direct the computing apparatus to:
determine a vector similarity score for each segment of the segments of the reference images with respect to the segment of the target image; and
identify ones of the segments of the reference images that are similar to the segment of the target image based on the vector similarity scores.

6. The computing apparatus of claim 5, wherein the program instructions further direct the computing apparatus to generate cluster segment scores for the segment of the target image based on aggregations of similarity scores for the identified ones of the segments of the reference images that are similar to the segment of the target image, wherein the aggregations are based on metadata of the reference images.

7. The computing apparatus of claim 1, wherein the similarity profile comprises a composite score for the target image, wherein the composite score is based on the similarity scores of the segments of the reference images with respect to the target image.

8. A method of operating a computing device, comprising:
identifying, from a database of images, reference images that are similar to a target image;
identifying segments of the reference images that are similar to a segment of the target image; and
generating a similarity profile of the target image based on similarity scores of the segments of the reference images with respect to the target image.

9. The method of claim 8, further comprising generating clusters of the reference images according to metadata of the reference images.

10. The method of claim 9, further comprising filtering the clusters of the reference images according to aggregate similarity scores of the clusters, wherein the aggregate similarity scores of the clusters are based on similarity scores of the reference images of the respective clusters with respect to the target image.

11. The method of claim 8, wherein identifying the reference images that are similar to the target image comprises determining a vector similarity score for each image of the database of images, wherein the vector similarity score indicates a similarity of the image to the target image based on embeddings of the target image and the image.

12. The method of claim 8, wherein identifying the segments of the reference images that are similar to the segment of the target image comprises:
determining a vector similarity score for each segment of the segments of the reference images with respect to the segment of the target image; and
identifying ones of the segments of the reference images that are similar to the segment of the target image based on the vector similarity scores.

13. The method of claim 12, further comprising generating cluster segment scores for the segment of the target image based on aggregations of similarity scores for the identified ones of the segments of the reference images that are similar to the segment of the target image, wherein the aggregations are based on metadata of the reference images.

14. The method of claim 8, wherein the similarity profile comprises a composite score for the target image, wherein the composite score is based on the similarity scores of the segments of the reference images with respect to the target image.

15. A method of operating a computing device, comprising:
identifying, from a database of images, reference images that are similar to a target image based on similarity scores of the reference images;
identifying clusters of the reference images that are similar to the target image, wherein the clusters are based on metadata of the reference images;
filtering the clusters of the reference images based on the similarity scores of the reference images;
identifying segments of the reference images that are similar to segments of the target image; and
generating a similarity profile of the target image based on similarity scores of the segments of the reference images with respect to the target image.

16. The method of claim 15, wherein identifying the reference images that are similar to the target image comprises determining a vector similarity score for each image of the database of images, wherein the vector similarity score indicates a similarity of the image to the target image based on embeddings of the target image and the image.

17. The method of claim 15, wherein filtering the clusters of the reference images based on the similarity scores of the reference images comprises:
generating cluster similarity scores for each of the clusters based on aggregating the similarity scores of the reference images in each cluster; and
retaining the reference images of selected ones of the clusters based on the cluster similarity scores.

18. The method of claim 15, wherein identifying the segments of the reference images that are similar to the segments of the target image comprises:
determining a vector similarity score for each segment of the segments of the reference images with respect to ones of the segments of the target image; and
identifying ones of the segments of the reference images that are similar to the ones of the segments of the target image based on the vector similarity scores.

19. The method of claim 18, further comprising:
for each segment of the segments of the target image:
generating a cluster segment score for each cluster of the clusters of the reference images, wherein, for a given cluster, the cluster segment score is based on aggregating the similarity scores of the identified ones of the segments of the reference images of the given cluster that are similar to the segment of the target image.

20. The method of claim 15, wherein the similarity profile comprises a composite score for the target image, wherein the composite score is based on the similarity scores of the segments of the reference images with respect to the segments of the target image.
